(19) United States
(12) Patent Application Publication
(10) Pub. No.: US 2014/0016540 A1
(43) Pub. Date: Jan. 16, 2014

(54) MBMS TRANSMISSION COOPERATIVE WITH RELAY

(71) Applicant: Steve Barrett, West Sussex (GB)

(72) Inventor: Steve Barrett, West Sussex (GB)

(73) Assignee: NVIDIA CORPORATION, Santa Clara, CA (US)

(21) Appl. No.: 14/007,191

(22) PCT Filed: Mar. 16, 2012
(86) PCT No.: PCT/EP12/54659

§ 371 Date: Sep. 24, 2013

(30) Foreign Application Priority Data
Mar. 24, 2011 (GB) 1104979.8

(51) Int. Cl. H04W 16/26

(52) U.S. Cl. CPC H04W 16/26
USPC 370/315

(57) ABSTRACT

A mobile communications network for communicating broadcast data to a plurality of mobile communications devices by transmitting the broadcast data via a wireless access interface, the mobile communications network including a plurality of base stations disposed throughout the network and arranged in operation to transmit signals to mobile communications devices attached to the base stations, and one or more relay nodes. One of the relay nodes is arranged in operation to receive a first signal representing the broadcast data transmitted by one or more of the base stations and to retransmit the broadcast data as a second signal, the first signal being broadcast for reception by a first mobile communications device and the relay node and the second signal being broadcast for reception by a second mobile communications device. The first signal is transmitted on a first channel of the wireless access interface, and the second signal is transmitted in a second channel of the wireless access interface,and one or more of the base stations is arranged to communicate data to a third mobile communications device in the second channel contemporaneously with the transmission of the broadcast data on the second channel by the relay node. Accordingly a relay node layer can be provided to a mobile radio network which improves an efficiency of use of the available communications resources.

### FIELD OF THE INVENTION

The present invention relates to mobile communications networks which are arranged to communicate data to and from mobile communications devices via a wireless access interface. The present invention also relates to mobile communications devices which communicate data with mobile radio networks, relay nodes for mobile communications networks and methods for communicating data with mobile radio networks.

### BACKGROUND OF THE INVENTION

Mobile communication systems have evolved over the past ten years or so from the GSM System (Global System for Mobiles) to the 3G system and now include packet data communications as well as circuit switched communications. The third generation project partnership (3GPP) has now begun to develop a mobile communication system referred to as Long Term Evolution (LTE) in which a core network part has been evolved to form a more simplified architecture based on a merging of components of earlier mobile radio network architectures and a radio access interface which is based on Orthogonal Frequency Division Multiplexing (OFDM) on the downlink and Single Carrier Frequency Division Multiple Access (SC-FDMA) on the uplink.

Multimedia Broadcast Multicast Service (MBMS) has been developed by the third generation project partnership (3GPP) to provide an arrangement in which data can be transmitted from one or more cells of a mobile radio network to mobile communications devices which have subscribed to that service. For example a television programme or multi media event can be transmitted to a plurality of mobile communications devices by contemporaneously transmitting broadcast data representing the programme or multi media event to the mobile communications devices from some or all of the base stations which form part of the network. An enhanced Multimedia Broadcast Multicast Service (eMBMS) is an arrangement which is provided within the standardisation of the LTE standards within 3GPP. In particular, the eMBMS standard utilises physical layer characteristics of the LTE standard which uses Orthogonal Frequency Division Multiplexing (OFDM) on the down link to transmit the eMBMS data to mobile communication devices. A feature of OFDM is that a Fourier Transform can be used to transform the time domain received OFDM symbol into the frequency domain. This is because the signal is formed in the frequency domain and transformed using an inverse FFT into the time domain for transmission. At the receiver the time domain signal, which may have reached the receiver from multiple paths and indeed multiple sources, is transformed into the frequency domain in order to recover data symbols carried by the OFDM symbol. As such, signals representing the OFDM symbol from a plurality of different sources are combined at the receiver in a constructive way. Thus, a single frequency network can be formed for eMBMS, which can be referred to as MBSFN. Indeed the e-UTRAN system is being developed within LTE to provide for a single frequency network mode of operation in which a single frequency network can be shared with non MBMS services. Other systems which can be used to form a single frequency network include the Integrated Mobile Broadcast (IMB) system which uses Code Division Multiple Access (CDMA) to form a single frequency network. For this example a spread spectrum signal can be received and combined from different sources using a Rake receiver.

It has been proposed in a document (CMCC (R2-103960) within LTE to use so-called relay nodes which can be disposed in a mobile radio network in order to extend a radio coverage of that mobile radio network and in particular in respect of MBMS services. A reply node is an autonomous unit which receives data transmitted by a base station and re-transmits that data to mobile communications devices, which may be within the range of the relay node, but outside the range of the base station, thereby increasing a range of the base station concerned.

In another disclosure entitled “Discussion on Technologies for Further Enhanced MBMS” by Alcatel Shanghai Bell, Alcatel-Lucent, published at 3GPP TSG-RAN WG RAN1#54 number R1-082815, there is disclosed an arrangement for MBMS transmission in a mobile communications network in which a plurality of base stations disposed throughout the network are arranged in operation to transmit a first signal representing broadcast data to mobile communications devices attached to the base stations, and one or more relay nodes are arranged in operation to receive the first signal representing the broadcast data and to retransmit the broadcast data as a second signal. The first signal is broadcast for reception by a first plurality of mobile communications devices and the relay nodes and the second signal is broadcast for reception by a second plurality of the mobile communications devices, one or more of which may be common to the first plurality of mobile communications devices. Furthermore, the first signal is transmitted on a first channel of the mobile communications network, and the second signal is transmitted on a second channel of a mobile communications network. Thus the second channel is on a different time and frequency to the first channel. A mobile communications device can therefore be arranged to receive the broadcast data from both the base station and the relay node and soft combine the received data to improve a likelihood of correctly recovering the broadcast data.

As will be appreciated, it is desirable to use communications resources available to a mobile radio network as efficiently as possible when providing wireless communications to mobile communications devices.

### SUMMARY OF THE INVENTION

According to the present invention there is provided a mobile communications network for communicating broadcast data to a plurality of mobile communications devices by transmitting the broadcast data via a wireless access interface, the mobile communications network including a plurality of base stations disposed throughout the network and arranged in operation to transmit signals to mobile communications devices attached to the base stations, and at least one relay node. The relay node is arranged in operation to receive a first signal representing the broadcast data transmitted by one or more of the base stations and to retransmit the broadcast data as a second signal, the first signal being broadcast for reception by a first mobile communications device and the relay node and the second signal being broadcast for reception by a second mobile communications device. The first signal is transmitted on a first channel of the wireless access interface, and the second signal is transmitted in a second channel of the wireless access interface, and one or more of the base stations is arranged to communicate data to a third mobile communications device in the second channel contemporaneously with the transmission of the broadcast data on the second channel by the relay node. Accordingly a relay node layer can be provided to a mobile radio network which improves an efficiency of use of the available communications resources.

It has been proposed within LTE (CMCC (R2-103960) to provide an arrangement in which a relay node receives a first signal transmitted by a base station (eNodeB) using a uni-cast bearer on a first time divided frame and in a second time divided frame the relay node and the base station are arranged to simultaneously broadcast (simul-cast) the data so that this data can be received from one or both of the signals transmitted by the relay node or the base station when the relay node and the base station are transmitting on the same frequency. Thus, the relay node and the base stations form a single frequency network. However, this proposal has a disadvantage in that essentially each of the base stations must transmit the data twice and furthermore there is a delay in transmitting the data to the mobile communications devices. Thus, if this arrangement were to be used to implement an MBMS system, for example, then this could potentially be wasteful of communications resources.

In one example the first channel on which the first signal is transmitted is provided by a first time slot within a first frequency band, and the second channel on which the second signal is transmitted is provided by a second time slot being after the first time slot and transmitted within a second frequency band which is different from the first frequency band.

Embodiments of the present invention can provide a mobile communications network in which a relay node is arranged to receive a first signal from a base station (eNodeB) and to re-transmit the broadcast data represented by the first signal as a second signal, the first signal being broadcast for reception to a plurality of mobile communication devices and the second signal being broadcast for reception to a plurality of mobile communications devices. The first signal may be transmitted in the first time slot within a first frequency band and the second signal may be transmitted in a second time slot being after the first time slot and transmitted within a second frequency band which is different from the first frequency band. As such, as the broadcast data is transmitted in a first time slot by the base station and the relay node transmits the same broadcast data having received the broadcast data from the base station as a second frequency and later time slot on a different frequency, a mobile device which can receive both the first signal and the second signal can be arranged to combine the first and second signals to recover the broadcast data or to select one or other of the first and second signals to recover the broadcast data. A mobile communications device which can receive only the first signal or the second signal can equally recover the broadcast data thereby providing an arrangement for a layer of relay nodes within the mobile communications system which does not require base stations to re-transmit the same broadcast data within a single frequency network.

According to some embodiments the mobile communications device is arranged to receive the first signal and to store the first signal in a suitable form and to receive the second signal and to combine the received second signal with the received first signal so as to recover the broadcast data with an improved likelihood of correctly detecting the broadcast data.

Various further aspects and features of the present invention are defined in the appended claims.

### BRIEF DESCRIPTION OF THE DRAWINGS

Example embodiments of the present invention will now be described with reference to the accompanying drawings where like parts are provided with the same designations and in which:

FIG. 1 is a schematic block diagram of a mobile radio network operating to support a multimedia broadcast multicast communications service;

FIG. 2 is a schematic block diagram of the mobile radio network shown in FIG. 1 adapted to include a relay node;

FIG. 3 is a schematic block diagram illustrating an arrangement in which one example of a donor base station (eNodeB) and a relay node are disposed in order to support a single frequency MBMS network;

FIG. 4 is a schematic block diagram illustrating an example of a donor base station and a relay node adapted according to the present technique;

FIG. 5 is an illustrative representation of a plot of frequency with respect to time for two transmissions, a first transmission from a donor eNodeB and a second transmission from a relay node;

FIG. 6a is a schematic illustration of an OFDM transmitter and FIG. 6b is a schematic illustration of an OFDM receiver;

FIG. 7 is a schematic block diagram of a communications device adapted in accordance with the present technique to receive of a transmission of MBMS data from a donor eNodeB and/or a relay node;

FIG. 8 is a schematic block diagram of a receiver forming part of the communications device shown in FIG. 7;

FIG. 9a is a graphical plot of frequency with respect of amplitude showing a relative location of narrow band carriers of a first OFDM symbol communicated on a first channel; FIG. 9b is a graphical plot of frequency with respect of amplitude showing a relative location of narrow band carriers of a second OFDM symbol communicated on a second channel; and FIG. 9c is a graphical plot of frequency with respect of amplitude showing a combination of the first and the second OFDM symbols;

FIG. 10 provides a graphical plot of MBMS transmissions of the same broadcast data on a first frequency channel by a donor base station and a second frequency channel by a relay node;

FIG. 11 is a corresponding illustration to that shown in FIG. 9 where transmission from a donor eNodeB and a relay node is substantially continuous on each frequency;

FIG. 12 provides a corresponding illustration of transmissions made by a base station from a cell in which uni-cast transmissions to relay nodes within a coverage area of the donor eNodeBs occur in the same timeslots as those of the MBMS transmissions from relay nodes;

FIG. 13 is a schematic illustration providing an overview of interference cancellation at a receiver resulting from transmissions from both a donor eNodeB and a relay node; and

FIG. 14 provides an example corresponding to that shown in FIG. 12 with uni-cast transmission being made from both a donor base station layer and a relay node layer in the same time/frequency blocks as those used for MBMS transmissions on the other layer.

### DESCRIPTION OF EXAMPLE EMBODIMENTS

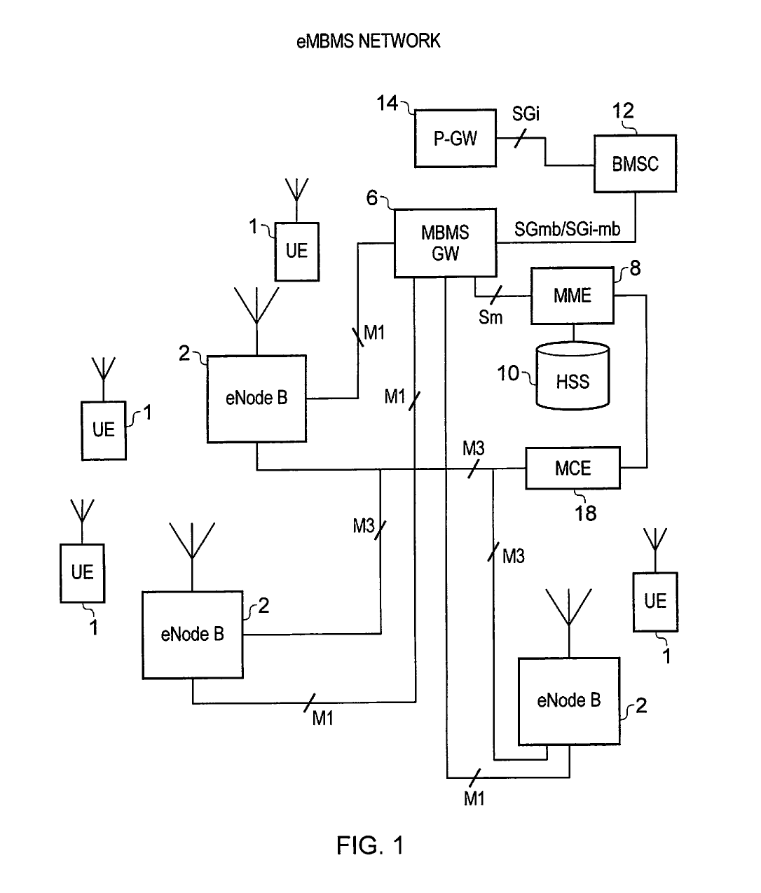

Embodiments of the present invention will now be described with reference to an implementation which uses a mobile radio network operating in accordance with the 3GPP Long Term Evolution (LTE) standard. In the following description an example application for embodiments of the present technique will be described with respect to enhance Multimedia Broadcast Multicast Services (eMBMS) such as that which is currently being proposed for the LTE project within 3GPP. FIG. 1 provides an example architecture of an LTE network, which has been adapted to form a network for supporting a Multimedia Broadcast Multicast Service (MBMS). As shown in FIG. 1 and as with a conventional mobile radio network, mobile communications devices designated as a mobile communications device (UE) 1 are arranged to communicate data to and from base stations 2 which are referred to in LTE as enhanced NodeBs (eNodeB).

The base stations or eNodeB's 2 are connected to a MBMS GW 6 which is arranged to perform routing and management of the MBMS services to the mobile communications devices 1 as they roam throughout the mobile radio network. In order to maintain mobility management and connectivity, a mobility management entity (MME) 8 manages the enhanced packet service (EPS) connections with the communications devices 1 using subscriber information stored in a home subscriber server (HSS) 10. Other core network components include a Broadcast Mobile Switching Centre (BMSC) 12, a packet data gateway (P-GW). More information may be gathered for the LTE architecture from the book entitled “LTE for UMTS OFDM and SC-FDMA based radio access”, Holma H. and Toskala A. page 25 ff, and the MBMS which is explained in 3GPP TS 36.300 V9.4.0 (2010-06).

Also forming part of the network shown in FIG. 1 is a multicell/multicast co-ordination entity MCE 22 which is a logical entity which may be part of another entity within the eMBMS logical architecture. The MCE performs functions such as admission control and the allocation of radio resources used by all of the eNodeB's in an MBMS single frequency network for multicell MBMS transmissions using MBSFN operations. Besides the allocation of time/frequency radio resources the MCE also decides other radio configuration functions. The MBMS gateway 6 on the other hand is arranged to send broadcast data packets for the MBMS to each of the eNodeB's transmitting the service. The MBMS gateway 6 uses for example IP multicast as a means for forwarding MBMS user data to the eNodeB's.

### Relay Nodes

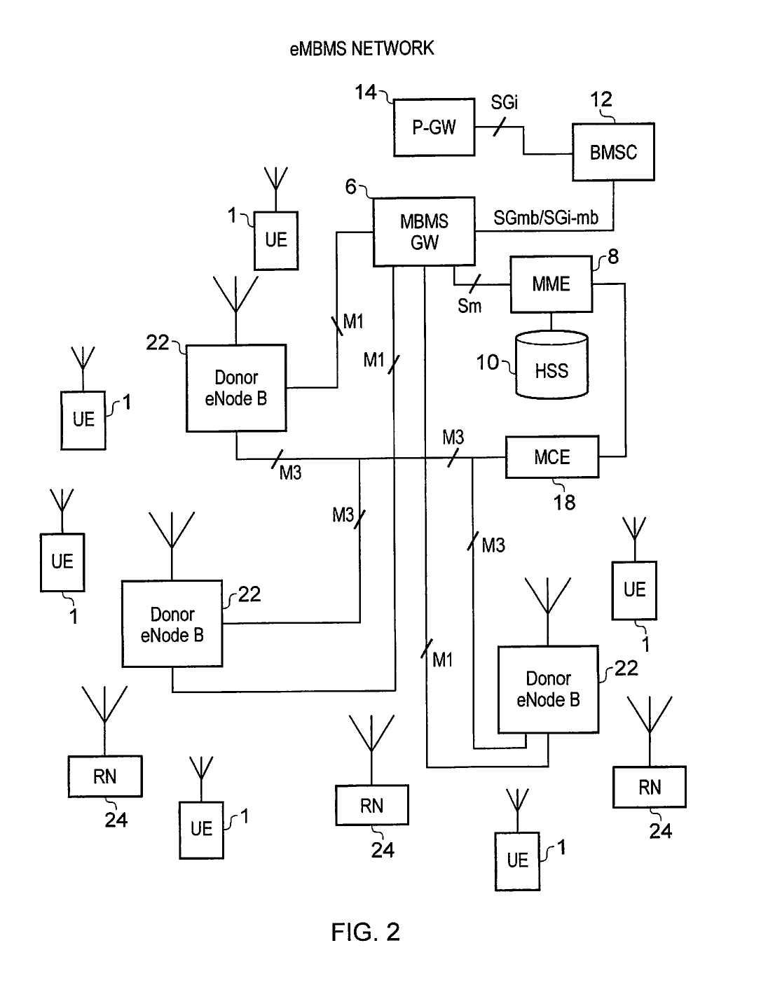

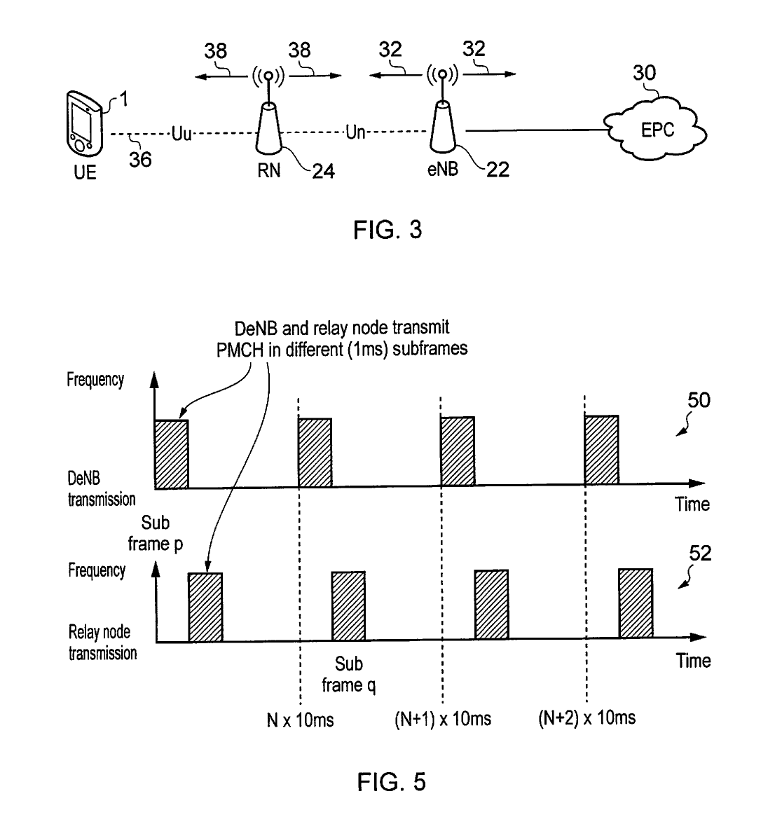

The mobile radio network shown in FIG. 1 is shown in FIG. 2 but adapted to include relay nodes for extending the range of the eNodeB's 22. Furthermore, in accordance with the present technique some adaptation of the eNodeB 22 is required in order to support the relay node deployment. The relay nodes 24 therefore form what can be termed as a relay node layer for transmission whereas the eNodeB 22 also form a layer of transmission for communicating the MBMS data packets to the mobile communications devices 1. Thus, the layer of relay nodes is deployed in order to extend the range of communication which can be achieved with the eNodeB's alone and finds application with a transmission of broadcast data to support eMBMS although not exclusively because other services can be supported. The operation of the relay node shown in FIG. 2 can be explained more easily with reference to a simplified representation shown in FIG. 3.

In FIG. 3 data packets such as those produced by a source of MBMS data are fed from an enhanced packet communication system EPS 30 to an eNodeB 22. The data packets are then received by the eNodeB 22 and transmitted on a pre-determined channel which broadcasts the MBMS data packets to one or more mobile communications devices within a range provided by the eNodeB which have subscribed to receive the MBMS data packets. Thus, the eNodeB is transmitting on a pre-designated channel the MBMS broadcast data as represented by arrow 32.

In order to extend the range of communication which can be achieved by the eNodeB 22 alone, a relay node 24 is disposed within a cell of the mobile radio network served by the eNodeB. The relay node 24 is arranged to receive the data from the MBMS channel communicated by the eNodeB 22 as if the relay node 24 was itself a mobile communications device. The relay node 24 then re-transmits the data in accordance with an MBMS communication so that the broadcast data can be received by one or more communications devices 1 which have subscribed to the MBMS service.

Embodiments of the present invention have therefore been devised in order to make improvements to the support of relay nodes in a mobile communications networks and in one example where the mobile communications network is supporting the communication of MBMS services.

In one known arrangement disclosed by CMCC (R2-103960), the relay node 24 is arranged to receive data from the unicast link 34 from the eNodeB 22. At this time however, the eNodeB is not broadcasting the MBMS broadcast data on the MBMS channel but simply communicating the data or a portion of that data in readiness for broadcast. At a pre-designated time perhaps at a later time slot within an OFDMA frame, both the eNodeB 22 and the relay node 24 transmit the MBMS data for reception by one or more mobile communications devices 1 within the mobile radio network. As such the re-transmission by both the relay node 24 and the eNodeB 22 can be arranged on the same frequency and same time slot thereby forming a single frequency network deployment as if the relay node 24 where itself an eNodeB. However a disadvantage is that the eNodeB 22 would have to transmit the data twice once for reception by the relay node on a unicast channel 34 and then again on a common MBMS broadcast channel 32, 38 contemporaneously with the relay node 24. Hence embodiments of the present technique seek to avoid repeated transmission of MBMS traffic by the eNodeB and to thereby make more efficient usage of radio resources. In addition since the unicast transmission is not received by any of the mobile communications device within the coverage area of the eNodeB or of the relay node then this potentially useful information is not used to improve the probability of detection of the subsequent MBMS transmission. Hence it is also desirable to improve a probability of detection of the MBMS signal by mobile communications device in a way that provides more efficient use of the radio spectrum.

### Adapted Relay Node

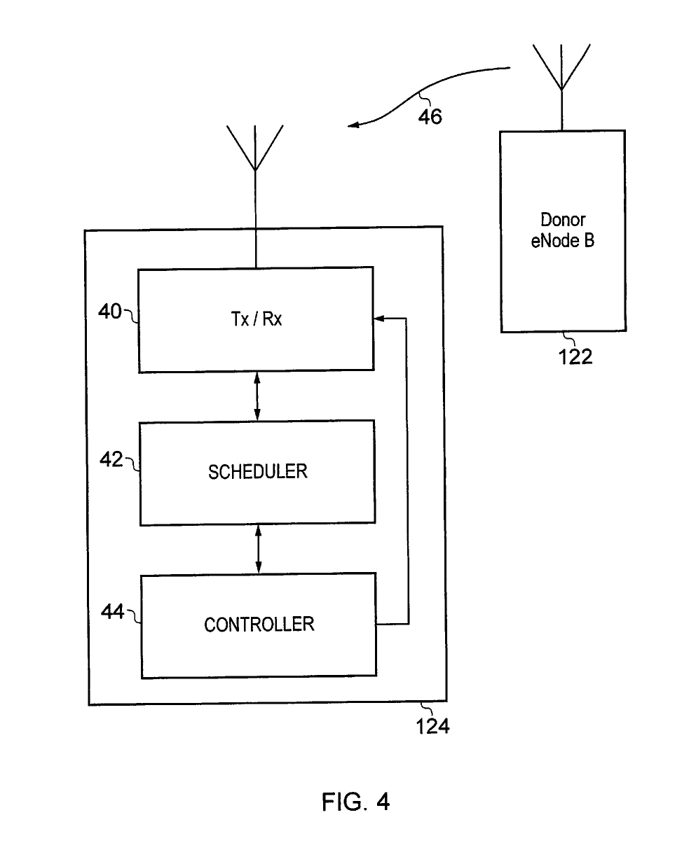

A relay node which has been adapted in accordance with the present technique is illustrated in FIG. 4. As shown in FIG. 4 a relay node 124 includes a transmitter and receiver unit 40 a scheduler 42 and a controller 44. The controller 44 is adapted to arrange for reception and transmission of data which is to be broadcast by the relay node having been received by the relay node. Thus the transmission and reception of data by the relay node 124 is effected using a scheduler which schedules transmission on time slots of sub-frames of the wireless interface of LTE and receives data via the LTE wireless access interface using the transceiver unit 40. The controller 44 is arranged to control the transceiver unit 40 and the scheduler 42 to perform operations required to receive the MBMS data and to transmit the MBMS data in accordance with the present technique.

According to the present technique the relay node 124 is arranged to receive data forming part of for example an MBMS transmission from a donor eNodeB 122. Thus, transmission from the eNodeB of the MBMS data is via an MBMS broadcast channel at a time t1 in each of a plurality of frames. As will be appreciated an MBMS transmission time interval (TTI) is 1 ms, a frame is 10 ms, so that if one sub-frame (1 ms) is allocated to MBMS then there will be a 9 ms gap between MBMS transmissions. According to the present technique the relay node 124 is arranged to receive the MBMS broadcast signal 46 to detect the data transmitted from the MBMS broadcast channel using the transceiver unit 40 in combination with the scheduler 42 and the controller 44 and to re-broadcast the MBMS data on a different channel. The channel may be both different in time as well as frequency.

In one example the arrangement is shown in FIG. 5 which provides an illustration of the transmission of broadcast data from the donor eNodeB shown in a first graph 50 of frequency with respect to time for the donor eNodeB and a corresponding graph of frequency with respect to time for the relay node 52. As can be seen in FIG. 5 the re-transmission by the relay node occurs at a second time t2 which is displaced from the first time t1 at which the donor eNodeB transmits the data from the first time. Furthermore, in some embodiments the relay node may transmit the data received at time t1 in frame p at a second time t2 in a sub-frame q and on a different frequency. As such a synchronised transmission of MBMS traffic over MBSFN made at time t1 in sub-frame p from all eNodeB's in an eNodeB layer is followed by transmission of the same MBSFN transmission (i.e. transmission of the same content) a few ms later from the relay node layer in subframe q (the time gap principally being greater at least than the sum of the MBMS TTI and any relay node processing delays) at time t2.

### Adapted Mobile Communications Device

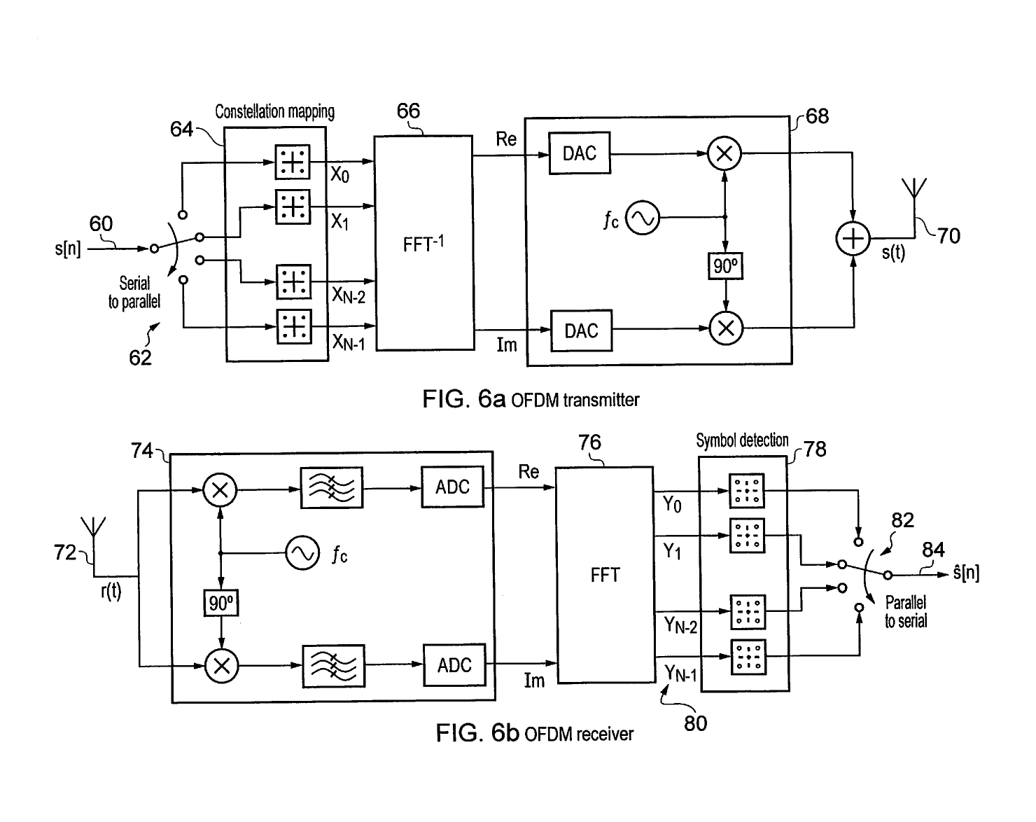

According to the present technique a mobile communications device may receive the data transmitted by the donor eNodeB 122 at time t1 and the data transmitted by the relay node 124 at time t2 and combine the data during reception in order to improve the likelihood of correctly recovering the data. Thus, the mobile communications device 1 is adapted to include a receiver which implements a reception technique which is illustrated in FIGS. 6, 7 and 8.

FIG. 6a provides an illustrative representation of a block diagram of a simplified representation of an OFDM transmitter. In FIG. 6a data to be transmitted is received on an input terminal 60 and mapped onto a plurality of constellation points for each of a plurality of narrow band transmission channels by a serial to a parallel converter 62 and a constellation mapper 64. An inverse Fast Fourier Transform (FFT) 66 then converts the set of narrow band carriers into the time domain which is then up converted and modulated for RF transmission by an RF front end 68 and transmitted from an aerial 70.

On the receiver side FIG. 6b includes a receive antenna 72 and an RF front end and down converter 74 for transforming the received OFDM symbol to a base band form. The real and imaginary components of the OFDM symbol which are converted by the RF front end 74 into the discrete time domain is then transformed from the time domain into the frequency domain by an FFT 76. A symbol decoder/detector 78 then converts the frequency domain data providing a symbol on each of the narrow band carriers at an output of the FFT 80 and forms for each of the symbols provided on the narrow band carriers an estimate of the data which is fed to a parallel to serial converter 82 and then output on an output channel 84 which provides an estimate of the originally transmitted data. The symbols decoder/detector 78 also typically includes an equaliser, which equalises the received base band frequency domain signal from the FFT 76 before the data symbols are recovered from the sub-carriers of the OFMD symbol.

As mentioned above a property of the OFDM allows signals received contemporaneously from different sources to be combined during reception. Thus, as far as a receiver of an OFDM signal is concerned the signal transmitted from a separate transmitter will appear as a separate transmission path as if the same signal has been transmitted on a different transmission path. Therefore provided a difference between the transmission paths is less than a cyclic prefix of repeated data samples of the OFDM symbol and the window of time domain samples for the FFT is synchronised to capture as much of the energy of the received signal as possible from the different transmission paths, then the FFT can recover data from a combination of the transmission parts.

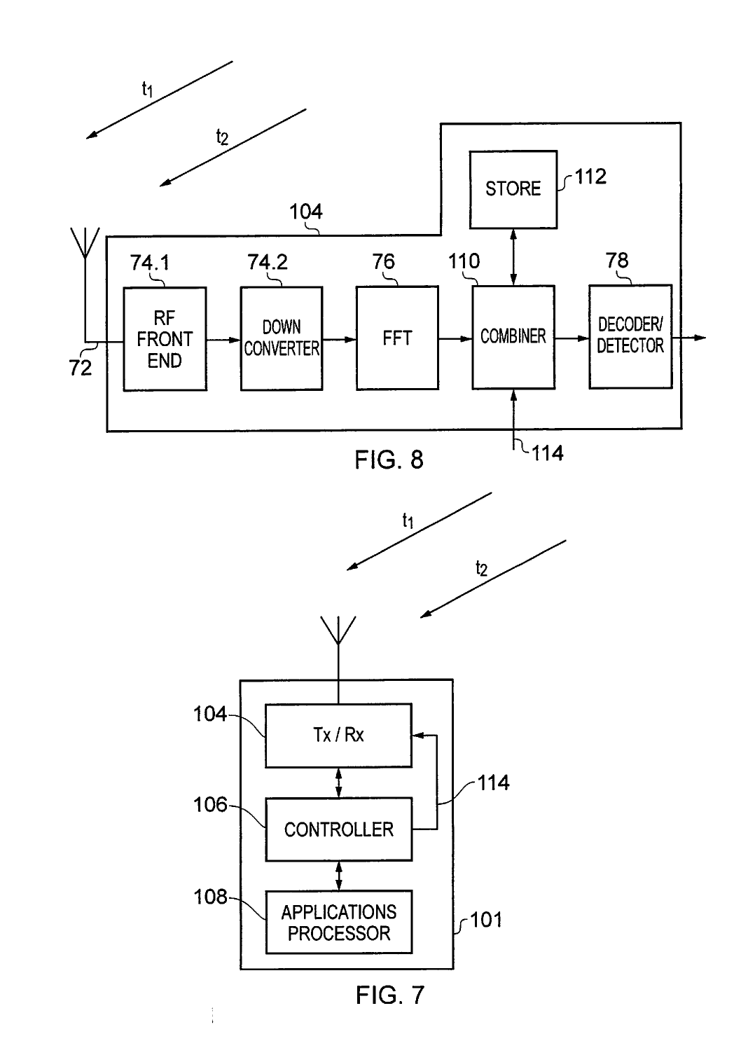

A mobile communications device 101 adapted to receive data transmitted by both the donor eNodeB and the relay node 122, 124 shown in FIG. 7 includes a transceiver unit 104 a controller 106 and an applications processor 108. The controller 106 controls the transceiver unit 104 to transmit and receive data to and from the transceiver unit 40 of the base station to support a communications service provided for example by an applications program executing on the processor 108, which for the present example is receiving an eMBMS service. For the present example, the controller 108 controls the transceiver unit 104 to receive both the first version of the broadcast data provided by the first signal on time t1 and the second version of the broadcast data provided by a second signal at a different time t2 as illustrated in FIG. 7. However, in order to combine the signals transmitted and received at times t1 and t2 the transceiver unit 104 is adapted to combine the first and second signals to recover the data. A receiver forming part of the transceiver unit 104 is shown in FIG. 8 with parts corresponding to the receiver shown in FIG. 6b having the same reference designations.

In FIG. 8 the OFDM signals received from the antenna 72 are passed to the RF front end and down converter 74 and fed to the FFT 76 which operates substantially as the receiver shown in FIG. 6b. However, the output of FFT 76 is fed to a combiner 110. The output combiner 110 uses a data store 112 to store data before combination. An output of the combiner feeds a decoder/detector 78 which performs the operation of the symbol detector shown in FIG. 6b.

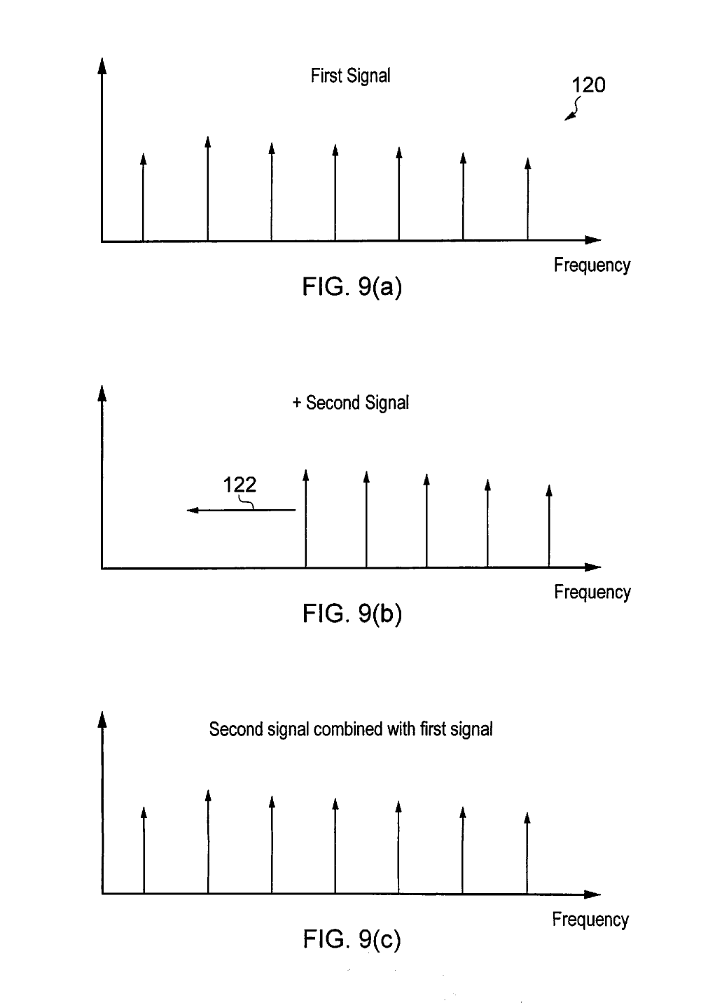

In operation the combiner 110 receives the first signal transmitted at time t1 as signalled by the controller 108 via a control channel 114. The combiner 110 determines a complex sample of the modulation symbol of each of the received OFDM frequency domain narrow band carriers and stores a digital representation of he complex received symbol within the data stored 112. Subsequently, the second signal is received on the second time slot and second frequency at time t2 and following similar operations forms at the output of the FFT 76 a set of symbols on the narrow band carriers which make up the OFDM symbol. As a result of the down conversion performed by the RF front end and down converter unit 74 the OFDM symbol has been converted to a base band domain. Complex samples representing each of the received modulation symbols from the narrow band carriers are identified with respect to the corresponding modulation symbols of the first signal stored in the data store 112 and a weighted summing/combining of these symbols is performed. Thus, as illustrated in FIG. 9a the narrow band carriers 120 of the first signal in the base band domain can be combined in the narrow band carriers of the second signal in the frequency domain after the narrow band carriers have been down shifted from their frequency channel as represented by an arrow 122 in FIG. 9b. Thus after down shifting the narrow band carriers according to the second signal, the sub-carriers of the OFDM symbol are now aligned in frequency so that they can be combined to form a composite signal as shown in FIG. 9c. Thereafter the decoder/detector 78 recovers the data from the composite signal to the effect of improving a likelihood of correctly recovering the data. This is as a result of combining OFDM symbols representing the same data which have been transmitted on different frequencies and at a different time t1, t2.

As part of the combining operation weights can be applied to each complex representation of a symbol received on one narrowband carrier before the vectors are summed, the weights may be set in proportion to the measured SNR on each carrier, which may for example be based on calculations of channel quality done for the purposes of producing a channel quality indicator (CQI) report. The summed vectors would then be supplied into the conventional LTE detection and channel decoding process for the purposes of decoding the MBMS codeword. In this case the scrambling code used in the eMBMS transmission from the donor eNodeB layer would need to be the same as the scrambling code used in the eMBMS transmission from the relay node layer.

In another approach the transmission on the donor eNodeB layer and the Relay Node layer are separately decoded. The mobile communications device performs a CRC (Cyclic Redundancy Check) to see whether either of the transmissions (from either relay node layer or from eNodeB layer) have been received correctly. If the CRC check is passed for either of the decoded blocks then the block is passed up to the higher layers for further processing (if CRC check is passed for both transmissions then one of the blocks is selected at random to be passed up to higher layers). This latter approach of selection combining will perform worse than the soft combining but will have the benefit of requiring less mobile communications device memory resources. In this case since selection combining is done after codeword detection the transmission from the relay node layer and the transmission from the DeNB layer can use different scrambling codes, and mechanisms would need to exist by which the mobile communications device knows or is informed of these scrambling codes.

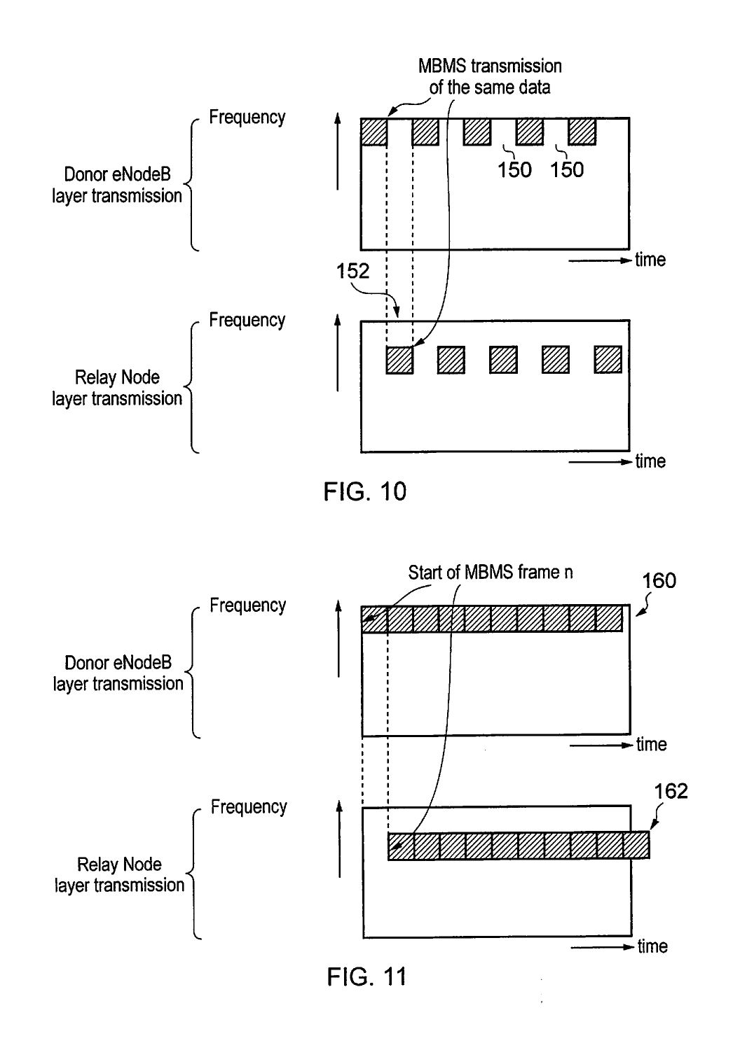

Note that in 3GPP Release 8 and 9, a given subframe must either be used for carrying PMCH (Physical MultiCast CHannel) or for carrying PDSCH (Physical Downlink Shared Channel). It is not allowed to mix PDSCH and PMCH on the same subframe. This restriction is put in place in order to simplify reference signal design [Sesia]. However, it should be noted that the invention described herein could in principle equally as well be applied to a system where a mixture of PMCH and PDSCH transmissions may occur on the same sub-frame. FIGS. 10 and 11 provide example in which ‘white space’ in the frequency time space in these diagrams could be occupied by PDSCH transmissions.

### Further Examples

As will be appreciated from the explanation provided above the version of the data transmitted via the second signal by the relay node could be within a different sub-frame. Such an example is shown in FIGS. 10 and 11. FIG. 10 provides an example in which a space between MBMS transmissions from the donor eNodeB 150 can be filled with the transmission of packet data according to the second signal by the relay node 152. Similarly FIG. 11 provides an example in which the data from the relay node is transmitted delayed by at least the sum of the MBMS TTI and the relay node processing delay but transmitted on different frequencies. Thus, as shown in FIG. 11 the representation of a series of data blocks which make up the packets of the MBMS communication are transmitted on a first frequency 160. After being received by the relay node from the eNodeB, the relay node transmits the data on a different frequency 162 but at a time substantially corresponding to that transmitted by the donor eNodeB.

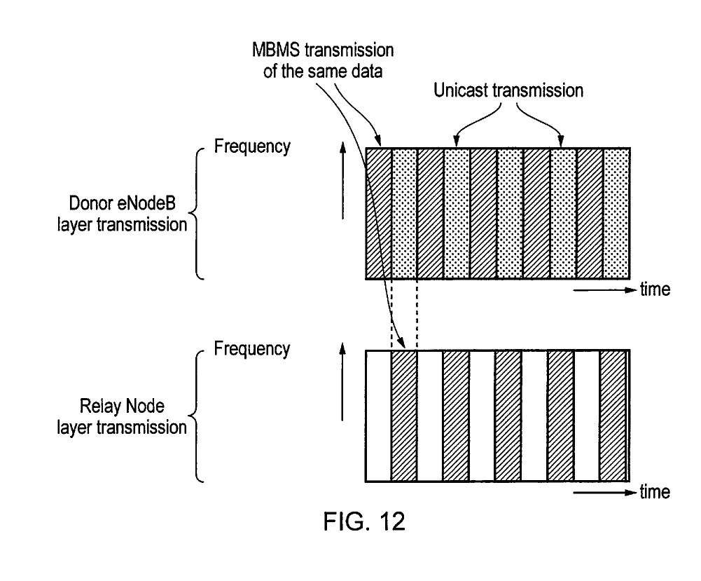

As will be appreciated in accordance with the present technique an alternative to the example embodiment described above would be if the mobile UE receives a uni-cast transmission of the data to be broadcast by the relay node. Thus as shown in FIG. 12 according to this example the donor eNodeB is able to make unicast transmissions on the sub-frames that are being used on the relay node for MBMS transmissions. In the second aspect the mobile communications device are arranged not to receive the unicast transmissions from the donor eNodeB but can wait for the MBMS transmissions from both the eNodeB layer and the relay layer before combining and decoding the MBMS data.

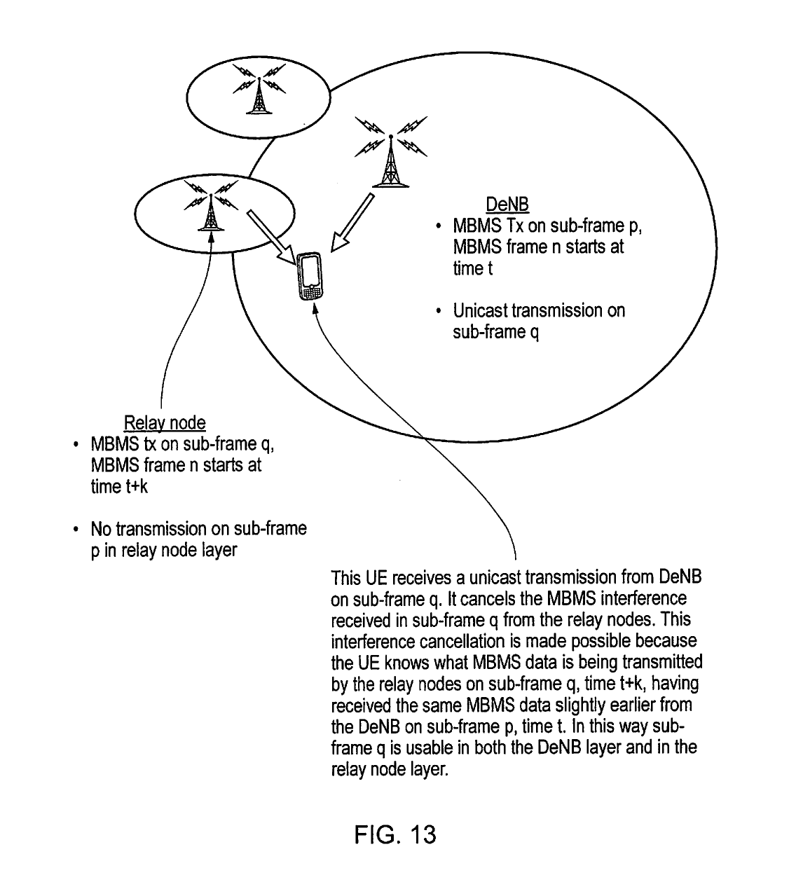

As a further example of the present technique FIGS. 12 and 13 represent a situation in which one of the eNodeB and/or relay node is permitted to make a transmission albeit a unicast transmission at the same time as the other of the relay node and the eNodeB are making transmissions.

In summary, embodiments of the present technique can provide a layer of relay nodes that enable physical layer combining of signals from both the eNodeB layer and the Relay Node layer, whilst avoiding repeated transmission of the same data from the eNodeB's. The fact that there is no repeated transmission lowers overall levels of interference in the system, which can be exploited to provide spectral efficiency improvements.

As will be appreciated the embodiments described above can be extended to the case where a daisy chain of relay nodes is attached to a single eNodeB. Where there are n relay nodes then there will be n+1 separate waves of transmission (i.e. n+1 transmissions to be combined). For the case of soft combining there may be significant memory requirements, which may potentially lead to a desire to reduce an MBMS transmission time interval (TTI) duration.

The scheme described above has the advantage of being simple to implement but has a disadvantage that radio resource efficiency may be sacrificed if Layer A is prohibited from transmitting on subframes that are being transmitted on by Layer B in order to reduce inter-cell interference. Hence in the example of FIGS. 12 and 13 a mechanism is provided which enables the Donor eNodeB to make unicast transmissions on the subframes that are being used by the relay node for MBMS transmission. In this embodiment, mobile communications devices's within the coverage of the Donor eNodeB, which are receiving unicast signals can cancel the interference from the relay node MBMS transmissions, because they know what data is being transmitted by the relay layer, having already decoded the MBMS transmission in a previous TTI. Relay node transmissions may be made at higher powers than usual so that mobile communications device within the coverage of the relay node can decode the relay transmission even in the presence of the unicast transmission from the eNode B layer. High power MBMS transmissions from the relay layer do not cause problems for the communications devices receiving the unicast traffic in the eNodeB layer because interference cancellation is possible.

In the example illustrated in FIGS. 12 and 13, mobile communications devices which are not receiving the unicast transmissions from the Donor eNodeB can still await the reception of MBMS transmissions from both the eNodeB layer and the relay layer before combining and decoding the MBMS transmissions.

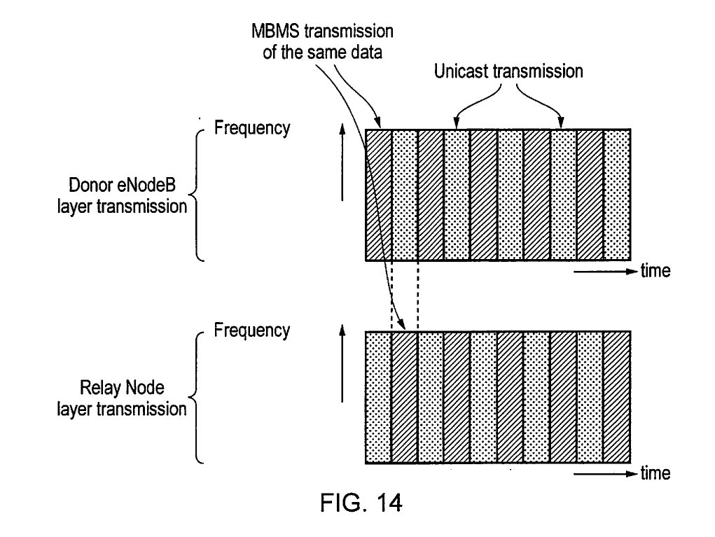

The example shown in FIGS. 10 and 11 has the advantage of being simple to implement but has the disadvantage that in order to manage inter-cell interference, radio resource efficiency may be sacrificed by prohibiting Layer A from transmitting on time/frequency blocks that are being transmitted on by Layer B. For the example illustrated in FIG. 14 each layer is allowed to make transmissions on time/frequency resources currently being used by the other layer. However, unicast transmissions must be made to mobile communications device that are close to the eNodeB or relay node so that transmit power levels from either eNodeB or relay node are low, hence ensuring that interference to MBMS receivers within the coverage of the other layer is minimised.

For this example, the scheduler preferentially schedules the unicast transmissions to mobile communications devices that are not receiving MBMS. In this way the MBMS communications devices are free to use their receivers to receive MBMS transmissions from both layers, so that combining across both layers may be achieved before decoding.

Various further aspects and features of the present inventions are defined in the appended claims. Various modifications may be made to the embodiments herein before described without departing from the scope of the present invention as defined in the appended claims. For example, embodiments can be applied to any mobile communications network utilising relay nodes and is not limited to LTE. Also embodiments are not limited to transmitting broadcast data of an MBMS but can be applied to the transmission of data for any service.

### REFERENCES

[Sesia] ‘LTE—the UMTS long term evolution—From theory to practice’, Sesia, Toufik, Baker
CMCC (R2-103960)

1. A mobile communications network for communicating broadcast data to a plurality of mobile communications devices by transmitting the broadcast data via a wireless access interface, the mobile communications network including
a plurality of base stations disposed throughout the network and arranged in operation to transmit signals to mobile communications devices attached to the base stations, and
a relay node arranged in operation to receive a first signal representing the broadcast data transmitted by one or more of the base stations and to retransmit the broadcast data as a second signal, the first signal being broadcast for reception by a first mobile communications device and the relay node and the second signal being broadcast for reception by a second mobile communications device, wherein the first signal is transmitted on a first channel of the wireless access interface, and the second signal is transmitted in a second channel of the wireless access interface, and one or more of the base stations is arranged to communicate data to a third mobile communications device in the second channel contemporaneously with the transmission of the broadcast data on the second channel by the relay node.

2. A mobile communications network as claimed in claim 1, wherein the first channel on which the first signal is transmitted is provided by a first time slot within a first frequency band, and the second channel on which the second signal is transmitted is provided by a second time slot being after the first time slot and transmitted within the first frequency or a second frequency band.

3. A mobile communications network as claimed in claim 1, wherein one of the first and second mobile communications devices is adapted to receive the first signal representing the data, to store a representation of the first signal, and to receive the second signal representing the data and to combine the first signal from the representation stored in the store with the second signal, to recover the broadcast data.

4. A mobile communications network as claimed in claim 1, wherein the first or the second mobile communications devices is adapted to receive the first signal representing the data, to store a representation of the first signal, and to receive the second signal representing the data and to select one of the first signal or the second signal and to recover the broadcast data from the select first or second signals.

5. A mobile communications network as claimed in claim 1, wherein the mobile communications device which is arranged to receive the data communicated by the base station on the second channel includes a receiver, the receiver being adapted to cancel the transmission in the second signal of the broadcast data contemporaneously received from the relay node in the second channel, using a version of the broadcast data received from the base station which has been transmitted in the first channel.

6. A mobile communications network as claimed in claim 1, wherein one or more of the base stations is arranged to communicate data to the third mobile communications device in the second channel contemporaneously with the transmission of the broadcast data on the second channel by the relay node, the data being transmitted by the base station in the second channel at a power level which is lower than a power of the transmission of the broadcast data in the second channel.

7. A mobile communications network as claimed in claim 1, wherein the relay node is arranged to communicate data to a fourth mobile communications device in the first channel contemporaneously with the transmission of the broadcast data on the first channel by the base station, the data being transmitted by relay node in the first channel at a power level which is lower than a power of the transmission of the broadcast data in the first channel.

8. A method of communicating broadcast data to a plurality of mobile communications devices by transmitting the broadcast data via a wireless access interface of a mobile radio network, the method comprising
providing the mobile radio communications network including a plurality of base stations disposed throughout the network and arranged in operation to transmit signals to and receive signals from mobile communications devices attached to the base stations, and
receiving at a relay node a first signal representing the broadcast data transmitted by one of the base stations,
retransmitting the broadcast data as a second signal, the first signal being broadcast for reception by a first mobile communications device and the relay node and the second signal being broadcast for reception by a second mobile communications device, wherein the first signal is transmitted on a first channel of the wireless access interface, and the second signal is transmitted in a second channel of the wireless access interface and the method includes
communicating data from one or more of the base stations to a third mobile communications device in the second channel contemporaneously with the transmission of the broadcast data on the second channel by the relay node.

9. A mobile communications device for receiving broadcast data from a mobile radio network, the mobile radio network including a plurality of base stations disposed throughout the mobile radio network and arranged in operation to transmit a first signals representing the broadcast data to mobile communications devices attached to the base stations via a wireless access interface, and a relay node is arranged to receive the first signal representing the broadcast data transmitted by the base station and to retransmit the broadcast data as a second signal, the mobile communications device comprising
a receiver which is arranged in operation
to receive the broadcast data as a first signal from one or more of the base stations, and
to receive the broadcast data as the second signal from the relay node, wherein the first signal is received from a first channel and the second signal is received from a second channel of the wireless access interface, and the receiver is arranged to combine the first and the second signals to recover the broadcast data.

10. A mobile communications device as claimed in claim 9, wherein the first channel on which the first signal is transmitted is provided by a first time slot within a first frequency band, and the second channel on which the second signal is transmitted is provided by a second time slot being after the first time slot and transmitted within the first frequency band or a second frequency band.

11. A mobile communications device as claimed in claim 9, wherein the receiver is adapted to receive the first signal representing the broadcast data, to store a representation of the first signal, and to receive the second signal representing the broadcast data and to combine the first signal from the representation stored in the store with the second signal, to recover the broadcast data.

12. A mobile communications device as claimed in claim 11, wherein the first signal is a first Orthogonal Frequency Division Multiplexed, OFDM, symbol and the second signal is a second OFDM symbol, each of the first and second OFDM symbols comprising a plurality of narrow band carriers and the receiver is arranged in operation to convert the first OFDM symbol to a baseband form and the second OFDM symbol to a base band form and to combine the first and the second signals by combining each of the respective narrow band carriers of the first and second OFDM symbols.

13. A mobile communications device as claimed in claim 9, wherein the receiver is adapted to combine the first signal and the second signal by receiving the first signal representing the data, storing a representation of the first signal, and receiving the second signal representing the data, selecting one of the first signal or the second signal and recovering the broadcast data from the select first signal or second signal.

14. A mobile communications device as claimed in claim 9, wherein the receiver is adapted to receive data communicated by one or more of the base stations in the second channel contemporaneously with the transmission of the broadcast data as the second signal in the second channel by the relay node, the receiver being adapted to cancel the second signal contemporaneously received from the relay node in the second time slot, using a version of the broadcast data received from the base station as the first signal which has been transmitted in the first channel.

15. A method of communicating broadcast data to a mobile communications device by transmitting the broadcast data via a wireless access interface of a mobile communications network, the mobile communications network including a plurality of base stations disposed throughout the network and arranged in operation to transmit signals to and receive signals from mobile communications devices attached to the base stations via the wireless access network, and one or more a relay nodes arranged to receive a first signal representing the broadcast data from by one of the base stations, and to retransmit the broadcast data as a second signal, the method comprising
receiving the broadcast data as the first signal from one or more of the base stations, and/or
receiving the broadcast data as the second signal from a relay node, wherein the first signal is received on a first channel and/or the second signal is received on a second channel of the wireless access interface, wherein the first signal is transmitted on a first channel of the mobile radio network, and the second signal is transmitted in a second channel of a mobile radio network.

16. A relay node for use in extending a coverage range of a base station operating within a mobile radio network for communicating broadcast data, the mobile radio network including a plurality of base stations disposed throughout the mobile radio network and arranged in operation to transmit signals to mobile communications devices attached to the base stations via a wireless access interface, the relay node comprising
a receiver which is arranged in operation
to receive a first signal representing the broadcast data transmitted by one or more of the base stations to the relay node and to retransmit the broadcast data as a second signal, the first signal being broadcast for reception by a first mobile communications device and the relay node and the second signal being broadcast for reception by a second mobile communications device, wherein the first signal is transmitted on a first channel of the mobile radio network, and the second signal is transmitted in a second channel of a mobile radio network.

17. A relay node as claimed in claim 16, wherein the first channel on which the first signal is transmitted is provided by a first time slot within a first frequency band of the wireless access interface, and the second channel on which the second signal is transmitted is provided by a second time slot being after the first time slot and transmitted within the first frequency band or a second frequency band.

18. A method of communicating broadcast data from a relay node to one or more mobile communications devices by transmitting the broadcast data via a wireless access interface of a mobile radio network, the method comprising
receiving at the relay node a first signal representing the broadcast data transmitted by one of the base stations,
retransmitting the broadcast data as a second signal, the first signal being broadcast to the relay node and the second signal being broadcast for reception by a the mobile communications devices, wherein the first signal is transmitted on a first channel of the wireless access interface, and the second signal is transmitted in a second channel of the wireless access interface.

19. A mobile communications network as claimed in claim 2, wherein one of the first and second mobile communications devices is adapted to receive the first signal representing the data, to store a representation of the first signal, and to receive the second signal representing the data and to combine the first signal from the representation stored in the store with the second signal, to recover the broadcast data.

20. A mobile communications network as claimed in claim 2, wherein the first or the second mobile communications devices is adapted to receive the first signal representing the data, to store a representation of the first signal, and to receive the second signal representing the data and to select one of the first signal or the second signal and to recover the broadcast data from the select first or second signals.
